(19) United States
(12) Patent Application Publication
(10) Pub. No.: US 2023/0346648 A1
(43) Pub. Date: Nov. 2, 2023

(54) TEAT AND DRINKING CONTAINER HAVING THE TEAT

(71) Applicant: KONINKLIJKE PHILIPS N.V., EINDHOVEN (NL)

(72) Inventors: DAAN HENDRIK GOSENSHUIS, WAALRE (NL); LUC BERNTSEN, EINDHOVEN (NL); SIETSE BART DE VRIES, EINDHOVEN (NL); WIETSE ELZINGA, DRACHTEN (NL)

(21) Appl. No.: 18/025,745

(22) PCT Filed: Sep. 16, 2021
(86) PCT No.: PCT/EP2021/075404

§ 371 Date: Mar. 10, 2023

(30) Foreign Application Priority Data
Sep. 21, 2020 (EP) 20197219.7

(51) Int. Cl. A61J 11/00

(52) U.S. Cl. CPC A61J 11/002

(57) ABSTRACT

A teat for a drinking bottle is formed from a wall with various different thicknesses. An air replenish valve has first and second valve portions of different thickness, and there are also different wall thicknesses in a cross section perpendicular to a teat axis, taken above the valve. These measures improve the reliability of the valve manufacture.

### FIELD OF THE INVENTION

This invention relates to teats for drinking bottles, for example for milk feeding bottles for infants.

### BACKGROUND OF THE INVENTION

Infant feeding bottles are used by parents to feed babies breast milk or formula milk when breast feeding is not possible, or as an alternative or supplement to breast feeding.

Typically, baby bottles have a soft flexible teat that mimics a breast shape and physical behavior.

In these teats, it is very common to have an air venting valve to allow air to enter the bottle when milk is drunk from the bottle. This is provided so that the baby can continuously drink without the need to release the bottle.

A very common air valve is a duck bill type of valve, having two flaps that (almost) touch each other to prevent milk flowing out and allow air to enter the bottle when there is a certain under-pressure in the bottle.

Current duck bill valves in flexible baby bottle teats have multiple problems.

The teat is typically injection molded, for example from a silicone material Typically, the valves are designed to be very small to prevent any unwanted opening of the valve, either by the production process, or by deformation of the rest of the teat. However, creating these small valves with typical wall thicknesses in the range of 200 to 500 μm can be very challenging. Especially the filling of the valve during the injection molding process is difficult.

When filling up the mold cavity with silicon, air needs to escape out of the molding tool by air venting channels that are usually located at the valve tip. If air is trapped inside, this can lead to short molds or air pockets. Rejects of the teats result, or else valves may be sold with severe leakage of milk out of the air valve.

GB 2 412 114 discloses a feeding bottle teat with an air valve with flexible side walls. One or both side walls has a thickness less than 0.4 mm to increase suppleness.

US 2005/252875 discloses another bottle teat with an air valve.

### SUMMARY OF THE INVENTION

The invention is defined by the claims.

According to examples in accordance with an aspect of the invention, there is provided a teat for a drinking bottle, comprising a single integral component formed by a wall, the teat comprising:
an upper nipple portion located at one end of a teat axis, with a nipple opening located in the upper nipple portion;
a base rim portion located at an opposite end of the teat axis; and
a valve formed between the upper nipple portion and the base rim portion or as part of the base rim portion, the valve having a first valve portion with a first, average, wall thickness, and a second valve portion with a second, average, wall thickness, which define between them a valve opening,
wherein the first valve portion is nearer to the teat axis than the second valve portion, and the second wall thickness is greater than the first wall thickness, and
wherein a third wall thickness in a cross section perpendicular to the teat axis, taken above the valve, is greater in the vicinity of the valve than a fourth wall thickness remote from the valve in said cross section.

The first and second valve portions correspond to each other, in the sense that they have the the same wall area, in particular viewed from internal volume of the valve. They preferably have the same wall shape (e.g. a rectangle or trapezium), and they each terminate at the valve opening (e.g. slit). They may for example include a same distance by which they extend from the valve opening. They may for example be mirror images of each other and hence symmetric in size and shape on each side of the valve opening. Thus, the first and second valve portions are the parts of the valve which deform to define the valve function.

The average wall thickness is the average wall thickness of each of the entire first and second valve portions. The first and second valve portions are for example the final deformable parts of the valve structure leading to, and terminating at, the valve opening. Thus, the thickness of these valve portions determines the flow conditions during molding which define the valve opening.

The base rim portion is for coupling to a container, for example for closing a container top opening. It may for example be for seating against an opening of the container although there may be an intermediate component between them. The valve allows air to enter to replenish the volume of drunk liquid.

The valve has portions which together form the valve opening. The valve portions are those parts of the valve which are intended to deform in use, i.e. the parts that influence the sealing function of the valve. They are the valve flaps for a flap type valve. The teat is typically made by injection molding from the nipple opening. By making the valve portion further from the injection point (because it is further from the teat axis) thicker than the valve portion more proximal to the injection point, the valve structure can more reliably be formed.

In addition, a thicker wall portion (relative to the remainder of the wall at that height up the teat) means that the injection molding material flows preferentially to the valve location, by having a reduced resistance to the flow.

These measures in combination enable a more reliable valve manufacturing process to be achieved, in particular based on injection molding.

There may be a single valve or multiple valves around the teat axis

The teat defines a ring around the teat axis in the cross section. This ring is typically circular but it may be non-circular. The cross section referred to above is preferably just above the valve, so the flow of liquid during injection molding passes through this cross section just before flowing to the valve. By “in the vicinity of the valve” means at the angular position around the ring corresponding to the angular position of the valve, whereas by “remote from the valve” (in that cross section) is meant at a different angular position around the ring to the angular position of the valve. Thus, the third third wall thickness is in an area through which there will be a flow during injection molding which will eventually reach the valve. Thus, there is a relatively reduced flow resistance for the path of injection molding fluid to the valve compared to the flow resistance to other parts of the structure.

The valve for example comprises a duck bill valve, wherein the first valve portion is a first valve flap, the second valve portion is a second valve flap and the opening is a valve slit. This is a common type of valve to be used as a one way air replenish valve, although other valve designs may be used.

The first and second valve flaps are for example oriented within 5 to 45 degrees of the teat axis. In other words, the valve is vertically oriented. Horizontal valve orientations may also be used.

The second valve flap is for example tapered such that the wall thickness narrows towards the valve slit. This may be used to improve the mechanical performance of the valve.

The valve for example has side portions which connect the first and second valve flaps (located at the opposite ends of the valve slit), and the side portions are also tapered such that the wall thickness narrows towards the valve slit.

The first and second valve flaps for example each have a length extending down to the valve slit in the range 1.5 mm to 2.5 mm. This length is the perpendicular length towards the valve slit of the movable valve flaps.

The teat may comprise a skirt portion below the upper nipple portion and a waist portion below the skirt portion, wherein the waist portion connects to the base rim portion. Thus, from the top down, there is a nipple portion, a skirt, a waist and then the base rim.

The cross section, where there is a thickening to promote material flow towards the valve, is then through the waist portion.

The waist portion for example comprises a closed shape including an arc portion of said third wall thickness in the angular vicinity of the valve. This arc portion of said third thickness is the part that promotes flow to the valve. It is locally in the vicinity, in particular above, the valve, and hence in the path of the flow of molding material from the nipple opening to the valve.

The valve is for example at a junction between the waist portion and the base rim portion. This keeps it as far away from the nipple portion as possible, so preventing the replenishing air being ingested by an infant using the teat.

The second valve portion may have a wall thickness greater than the wall thickness of the first valve portion at least at a region of the valve portion in the vicinity of the valve opening. This is the at or near the final molding point for the valve.

The second, average, wall thickness is for example in the range 1.2 to 2.5 times the first, average, wall thickness. The second, average, wall thickness is for example in the range 0.25 mm to 0.6 mm and the first, average, wall thickness is for example in the range 0.2 mm to 0.3 mm.

The third wall thickness is for example in the range 1.5 to 5 times the fourth wall thickness. The fourth wall thickness is for example in the range 250 μm to 1 mm.

The wall is for example silicone, and the teat is injection molded through the nipple opening.

The invention also provides a feeding bottle comprising:
a container; and
the teat defined above.

A securing member may be provided for securing the teat to the container, although this securing function may instead be performed by the teat itself.

This securing member may be a screw on disc, but other ways of holding the teat over the container are known such as a hinged lid.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a typical drinking bottle;

FIG. 2 shows a first example of a known teat;

FIG. 3 shows a second example of known teat;

FIG. 4 shows an example of a teat design in accordance with the invention, in cross sectional view;

FIG. 5 shows the area of the valve in more detail;

FIG. 6 illustrates the cross section as VI-VI of FIG. 4; and

FIG. 7 shows the result of modelling the injection molding process; and

FIG. 8 shows that sides of the valve may also taper towards the valve slit.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a teat for a drinking bottle, which is formed from a wall with various different thicknesses. An air replenish valve has first and second valve portions of different thickness, and there are also different wall thicknesses in a cross section perpendicular to a teat axis, taken above the valve. These measures improve the reliability of the valve manufacture.

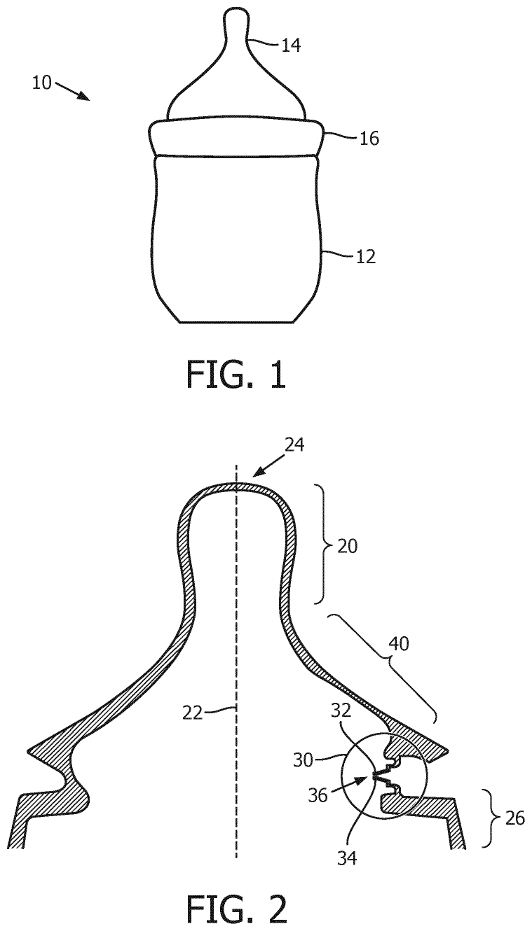

FIG. 1 shows a typical drinking bottle for bottle feeding a baby or infant using a teat. The drinking bottle 10 comprises a container 12, a teat 14 and a connection ring 16 which secures the teat 14 to the container. The connection ring for example screws over a thread at the top of the container. The teat closes the container top opening.

FIG. 2 shows a first example of a known teat 14.

The teat 14 has an upper nipple portion 20 located at one end of a teat axis 22 and a nipple opening 24 at an upper end of the nipple portion 20. The nipple opening may be recessed back from the very top of the nipple portion (an example is shown in FIG. 4).

A base rim portion 26 is located at an opposite end of the teat axis for seating against an opening of the container 12.

Note that the top or upper parts are defined as those nearest the nipple and the bottom, base or lower parts are defined as those nearest the rim. These terms are simply used for convenience and do not imply any particular orientation (with respect to the direction of gravity).

A valve 30 is formed between the upper nipple portion 20 and the base rim portion 26.

The valve has a first valve portion 32 and a second valve portion 34 which define between them a valve opening 36. The first valve portion 32 is nearer to the opening 24 than the second valve portion 34, and thus during injection molding, it will be filled first.

The valve also has side portions, not shown, which connect the first and second valve portions at the ends of the valve opening.

There is a skirt portion 40 below the upper nipple portion 20. This provides a gradual widening from the desired nipple size e.g. around 10 mm diameter, to the desired container size, e.g. 40 mm diameter. It mimics the shape of a breast.

The teat is generally rotationally symmetric, i.e. other than the valve. It may be generally circular but it may also be non-circular.

The teat 14 is injection molded, using the nipple opening 24 as the liquid entry and air escape point.

FIG. 2 shows an example based on a duck bill valve. The first valve portion 32 is a first valve flap, the second valve portion 34 is a second valve flap and the opening 36 is a valve slit.

FIG. 2 shows the duck bill valve with the valve flaps generally perpendicular (e.g. within a range 5 to 45 degrees, such as below 15 degrees) to the teat axis 22.

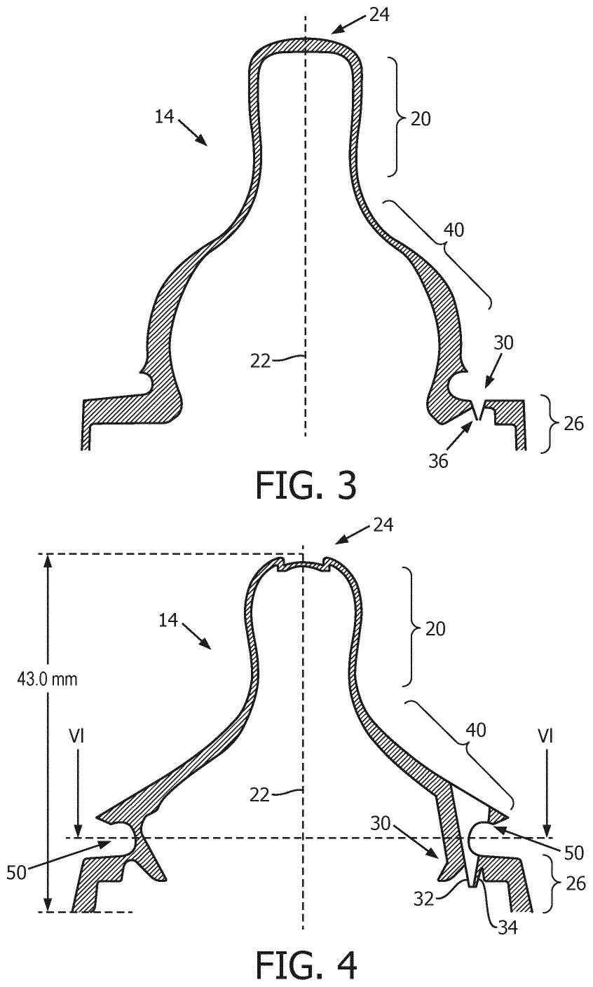

FIG. 3 shows that the duck bill valve may instead have the valve flaps generally parallel (e.g. within a range 5 to 45 degrees, such as below 15 degrees) to the teat axis 22. The radially outermost valve flap is then further from the nipple opening.

The nipple opening is shown located along the teat axis in this example. This is not essential—it may be offset from the central teat axis or there may be multiple openings.

FIG. 4 shows an example of a teat design in accordance with the invention, in cross sectional view.

The teat has generally the same design as FIG. 3 and the same reference numbers are used for the same components. Thus, the teat 14 has an upper nipple portion 20 located at one end of the teat axis 22 with the nipple opening 24, the base rim portion 26, the valve 30 between the upper nipple portion 20 and the base rim portion 26, and the skirt portion 40 below the upper nipple portion 20.

The design of FIG. 4 has two modifications compared to the design of FIG. 3.

A first modification is that the valve has different wall thicknesses for the first and second valve portions (which define between them the valve opening 36). In particular, the second valve portion 34 has an average wall thickness (which will be called a second wall thickness) greater than an average wall thickness of the first valve portion 32 (which will be called a first wall thickness).

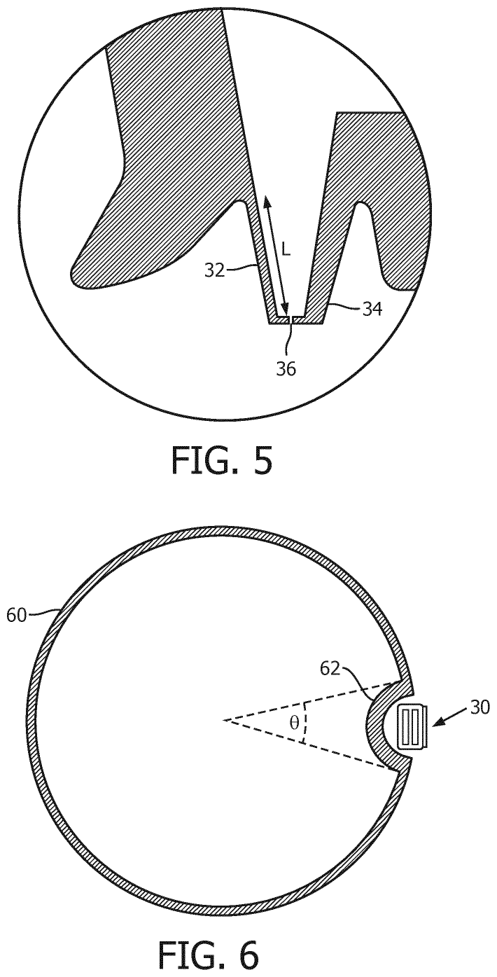

FIG. 5 shows the area of the valve 30 in more detail. The valve in this example is again a duck bill valve with the first valve portion 32, i.e. first valve flap, nearer to the teat axis, and hence nearer to the opening 24 in terms of the flow of injection molding fluid, than the second valve portion 34, i.e. second valve flap.

The first valve flap 32 has a length L (perpendicular to the valve slit 36 and in the direction toward the valve slit) of around 2 mm (e.g. 1.5 mm to 2.5 mm). This is the length of the valve flap portion over which deformation takes place in response to pressure differences. The wall thickness over this 2 mm length is approximately a constant 0.25 mm (e.g. in the range 0.2 mm to 0.3 mm). Thus, the first wall thickness (the average) is in this case 0.25 mm.

The second valve flap 34 has the same length L (perpendicular to the valve slit 36 and down toward the valve slit) of around 2 mm (e.g. 1.5 mm to 2.5 mm). The wall thickness over this 2 mm length in this example tapers from 0.6 mm remote from the valve slit to 0.4 mm in the vicinity of the valve slit. Thus, the second wall thickness (the average) is in this case 0.50 mm (e.g. in the range 0.25 mm to 0.6 mm).

The region of length L is the part of the valve that is intended to deform in use. The regions on each side of the valve for example correspond to each other in size and shape.

The first valve flap may also taper as well, or else both valve flaps may have uniform thickness. The side portions of the valve (not shown as they are in front of and behind the cross section shown) may also taper toward the valve slit.

The teat 14 is injection molded, using the nipple opening as the liquid entry point.

By making the valve portion 34 further from the teat axis, and further from injection point in terms of the flow from the injection point, thicker than the valve portion more proximal to the teat axis and hence injection point, the valve structure can more reliably be formed since the molding liquid can more uniformly be delivered to the different parts of the valve, despite their different distances from the injection point. This is achieved by the different flow resistances caused by the different wall thicknesses.

A second modification is that a thicker wall portion is provided above the valve relative to the remainder of the wall at that same height up the teat (i.e. the same position along the teat axis). This means that the injection molding material flows preferentially to the valve location, in particular the angular orientation of the valve around the ring of material formed around the teat axis, again by having a reduced resistance to the flow.

Returning to FIG. 4, the teat has a waist portion 50 below the skirt portion 40. The waist portion 50 connects to the base rim portion 26. Thus, from the top down, there is the nipple portion 20, the skirt portion 40, the waist portion 50 and then the base rim 26.

The valve 30 is at a junction between the waist portion 50 and the base rim portion 26.

The waist portion 50 in this example is narrower than the radially outermost part of the skirt portion 40, so provides a narrowing. This provides some flexibility for the nipple portion 20 and skirt portion to bend away from the teat axis. However, the skirt portion does not need to narrow—it may have the same outer size as the lowest extremity of the skirt portion.

The flow of molding material to the base rim 26 and to the valve 30 takes place through the waist portion 50. Thus, the waist portion controls the flow to the valve, and it is designed again to improve the molding process of the valve.

In particular, a third wall thickness of a cross section perpendicular to the teat axis 22, taken above the valve 30, is greater in the vicinity of the valve than a fourth wall thickness remote from the valve.

FIG. 4 illustrates this cross section as VI-VI and it is shown in FIG. 6.

FIG. 6 shows that waist portion comprises a closed shape having a circular arc portion 60 of the fourth wall thickness around at least 300 degrees (so the angle θ shown is less than 60 degrees). A portion 62 of the third wall thickness closes the closed shape. This has an angle of less than 60 degrees. Of course, in a design with multiple valves, the portion 60 will be divided into multiple sections, and there will be multiple portions 62.

The portion 62 is the part that promotes flow to the valve. It is locally in the vicinity, in particular above, the valve, and hence in the path of the flow of molding material from the nipple opening to the valve via the waist portion.

By way of example, the third thickness of the portion 62 may be in the range 1 mm to 3 mm and the fourth thickness of the portion 60 may be in the range 0.3 mm to 1 mm.

The third wall thickness is for example in the range 1.5 to 5 times the fourth wall thickness.

These measures in combination enable a more reliable valve manufacturing process to be achieved, in particular based on injection molding, in particular by improving the venting process during molding.

The nipple portion, skirt portion and base rim are rotationally symmetric, but both the valve and the waist portion now disturb the overall rotational symmetry.

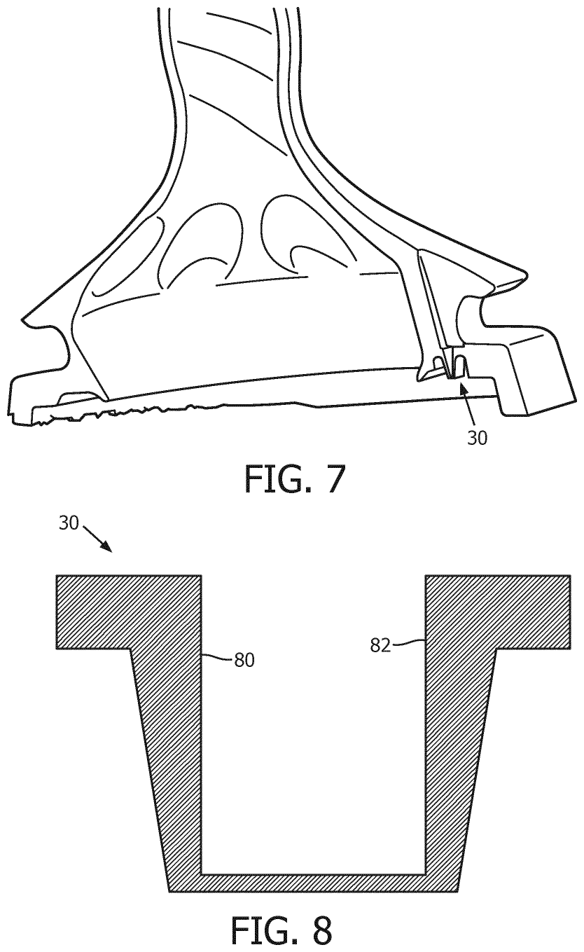

FIG. 7 shows (in somewhat schematic form) the result of modelling the injection molding process. Different shades of grey represent the time at which the molding liquid (silicone) reaches the different parts of the mold. The invention enables the valve formation to be reliably completed before the base rim portion is formed. This can generally be seen by the dark shading of the base rim portion.

The invention thereby provides an optimal teat design for robust manufacturing to prevent leakage of the air valve due to non-filling in the injection molding process. The valve is located far from the teat tip, but can still be filled in a robust manner.

As mentioned above, the sides of the valve may also taper towards the valve slit. This is shown in FIG. 8, which is a cross section in a plane including the valve slit, so that the length direction of the valve slit is the left-right direction in FIG. 8. The valve has sides 80, 82 which may for example taper with the similar wall thickness to the valve flaps, such as a thickness in the range 0.3 mm to 1 mm, for example a taper from 0.6 mm to 0.4 mm.

The invention has been described in connection with a vertical valve (i.e. generally parallel to the teat axis). The same approach may be applied to a horizontal valve (i.e. generally perpendicular to the teat axis).

Generally, the wall thickness in the valve will lie in the range of 250 μm to 1 mm, and the length and width are of the order of 1-10 mm.

The approach has been described with reference to a duck bill valve, but other valve designs, such as a domed slit valve, may be used.

Only a single valve has been shown in the examples above, but there may be two or more valves at different angular positions around the teat axis. Each valve may then have the design as explained above.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. A teat for a drinking bottle, comprising a single integral component formed by a wall, the teat comprising:
an upper nipple portion located at one end of a teat axis, with a nipple opening located in the upper nipple portion;
a base rim portion located at an opposite end of the teat axis; and
a valve formed between the upper nipple portion and the base rim portion or formed as part of the base rim portion, the valve having a first valve portion with a first, average, wall thickness, and a second valve portion with a second, average, wall thickness, which define between them a valve opening, wherein the first and second valve portions are the parts of the valve which are intended to deform in use,
wherein the first valve portion is nearer to the teat axis than the second valve portion, and the second wall thickness is greater than the first wall thickness, and
wherein a third wall thickness in a cross section perpendicular to the teat axis, taken above the valve, is greater in the vicinity of the valve than a fourth wall thickness remote from the valve in said cross section.

2. The teat of claim 1, wherein the valve comprises a duck bill valve, wherein the first valve portion is a first valve flap, the second valve portion is a second valve flap and the opening is a valve slit.

3. The teat of claim 2, wherein the first and second valve flaps are oriented within 5 to 45 degrees of the teat axis.

4. The teat of claim 2, wherein the second valve flap is tapered such that the wall thickness narrows towards the valve slit.

5. The teat of claim 4, wherein the valve has side portions which connect the first and second valve flaps, and the side portions are tapered such that the wall thickness narrows towards the valve slit.

6. The teat of claim 1, comprising a skirt portion below the upper nipple portion and a waist portion below the skirt portion, wherein the waist portion connects to the base rim portion.

7. The teat of claim 6, wherein said cross section is through the waist portion.

8. The teat of claim 6, wherein the waist portion comprises a closed shape including an arc portion said third wall thickness in the vicinity of the valve.

9. The teat of claim 6, wherein the valve is at a junction between the waist portion and the base rim portion.

10. The teat of claim 1, wherein the second valve portion has a wall thickness greater than the wall thickness of the first valve portion at least at a region of the valve portion in the vicinity of the valve opening.

11. The teat of claim 1, wherein the second, average, wall thickness is in the range 1.2 to 2.5 times the first, average, wall thickness

12. The teat of claim 1, wherein the second, average, wall thickness is in the range 025 mm to 0.6 mm and the first, average, wall thickness is in the range 0.2 mm to 0.3 mm.

13. The teat of claim 1, wherein the third wall thickness is in the range 1.5 to 5 times the fourth wall thickness.

14. The teat of claim 1, wherein the wall is silicone.

15. A feeding bottle comprising:
a container;
the teat (14) of claim 1.
